(19) United States
(12) Patent Application Publication
(10) Pub. No.: US 2009/0103811 A1
(43) Pub. Date: Apr. 23, 2009

(54) Document camera and its method to make an element distinguished from others on a projected image

(75) Inventors: Jung-Yu Chen, Chung Ho City (TW); Yung-Hsi Wu, Chung Ho City (TW); Po-Chih Hung, Chung Ho City (TW); Jiun-Shin Wu, Chung Ho City (TW)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: AverMedia TECHNOLOGIES, INC.

(21) Appl. No.: 12/004,711

(22) Filed: Dec. 21, 2007

(30) Foreign Application Priority Data
Oct. 23, 2007 (TW) 96139766

(51) Int. Cl. G06K 9/46; G06F 3/033

(52) U.S. Cl. 382/190; 345/163

(57) ABSTRACT

The invention discloses a document camera and a method to make an element distinguished from others on a projected image, the method which implements on the document camera, firstly to capture an image, then to generate a cursor image and paste it onto the image according to a latest relative coordinate of a movement performed by a cursor controller, next to detect whether the cursor image is approximate to an element with a closed contour on the image, when an element with closed contour is detected, then to make the element distinguished from others on the image; eventually, to output the image with the distinguished element.

### RELATED APPLICATIONS

This application claims priority to Taiwan Application Serial Number 96139766, filed Oct. 23, 2007, which is herein incorporated by reference.

### BACKGROUND

1. Field of Invention

The present invention is related to a document camera, and more particularly to a document camera and its method to make the partial element distinguished on a projected image.

2. Description of Related Art

The conventional art of a document camera is capable of obtaining an image of an object through a procedure of video capture, and projecting a magnified image of the object by a video outputting apparatus. The object image in which the object for example can be a piece of printed paper, is magnified on the wall to provide an audience with a large view of forms or pictures from the printed paper to obtain the detailed information thereof. A laser pointer or a cursor will be utilized by demonstrators to point out the current part of a presentation to help an audience to easily follow the current part thereof when audiences get lost during the presentation.

In view of some reasons for unobvious light-spot of the laser pointer, tiny cursor, bad printing quality of the forms or pictures on the printed paper, or limited area of presented forms or pictures on the projected image, an audience is still unable to get the point from the current part of projected image regarding the presentation. Therefore, an issue is being raised regarding how to design a document camera and its method to obviously distinguish the presented element from the projected image of the object and to clearly teach the audience about the point of the presentation.

### SUMMARY

It is therefore an objective of the present invention to present a document camera and its method to make an element distinguished from others on a projected image to provide a function of being an element distinguishable on a projected image.

To achieve the foregoing objective, a document camera at least comprises a video capturing module, a digital processing module, a central controlling module and a video outputting module, wherein the digital processing module electrically connects to the video capturing module, the video outputting module and the central controlling module respectively. The video capturing module is provided to continually capture an object image from an object and to sequentially send the object images to the digital processing module.

The document camera further has a cursor controller electrically connected to the central controlling module. The cursor controller provides the central controlling module to calculate a latest relative coordinate of a cursor image on the object image in accordance with a movement performed by the cursor controller.

According to the latest relative coordinate of the cursor image provided from the central controlling module, the digital processing module is provided to paste the cursor image on the object image, to detect whether an element on the object image which is approximated to the cursor image features a closed contour, to make the element distinguished from others on the object image when the digital processing module detects an element with closed contour. The digital processing module makes the element distinguished from others on the object image. The digital processing module can raise the volume of brightness, contrast, size and contour thereof on the object image. The video outputting module is provided to output the object image with the cursor image and the distinguished element to a wall for an audience after receiving from the digital processing module.

Another presentation of the present invention discloses a document camera at least comprising a video capturing module, a digital processing module, a central controlling module and an outputting interface, wherein the video capturing module is provided to continually capture an image, the central controlling module is provided to calculate a latest relative coordinate of a cursor image staying on the image in accordance with a movement performed by the cursor controller, and the digital processing module electrically and respectively connected the video capturing module and the central controlling module is provided to paste the cursor image on the image according to the latest relative coordinate to produce a first digital video image, to detect any element with closed contour on the first digital video image according to the latest relative coordinate of the cursor image, to make the element distinguished from others on the first digital video image and to overlay the distinguished element back to the first digital video image to produce a second digital video image, and the output interface electrically connected to the digital processing module is provided to connect and output the second digital video image to an external video projector.

The other presentation of the present invention discloses a method to make an element distinguished from others on a projected image, which implements on a document camera, firstly to capture an image from an object, then to generate a cursor image and paste it on the image according to a latest relative coordinate of a movement performed by a cursor controller, next to detect whether an element with a closed contour approximated to the cursor image on the image, while the element with the closed contour is detected, then to make the element distinguished from others on the image; eventually, to output the image with the cursor image and the distinguished element.

According to an embodiment of the present invention, when an element with closed contour is detected, the digital processing module performs processes to present the distinguished element thereof, one of the processes can be first raising the value of component (Y) from (Y, Cb, Cr) of all of pixels of the element and then overlaying the processed element of the original one on the first digital video image that the original one used to be, thus to achieve an enhancement of the volume of brightness of the element with closed contour.

The second process can be first multiplying the value of component (Y) from (Y, Cb, Cr) of all of pixels of the element and then overlaying the processed element of the original one on the first digital video image that the original one used to be, thus to achieve an enhancement of the volume of contrast of the element with closed contour.

The third process can be first magnifying all of pixels of the element with equal ratio and then overlaying the processed element of the original one on the first digital video image that the original one used to be, thus to achieve an enlargement of the size of the element with closed contour.

The fourth process can be first reinforcing the contour of the element with equal ratio and then overlaying the processed element of the original one on the first digital video image that the original one used to be, thus to achieve a bolder contour of the element with closed contour.

Finally, the method and camera documents of the present invention disclosed above are able to change the brightness, contrast, size and contour of the element with closed contour, whenever a cursor image controlled by the cursor controller approaches. Therefore, the present invention both meets the consumer's need and wins larger market competition due to overcoming the drawbacks of unobvious light-spot of the laser pointer, tiny cursor and bad printing quality of the printed paper to help an audience see an introducing target of a projected video clearly and to follow the presentation point easily.

### BRIEF DESCRIPTION OF THE DRAWINGS

The structure and the technical means adopted by the present invention to achieve the above and other objects can be best understood by referring to the following detailed description of the preferred embodiments and the accompanying drawings, where:

FIG. 1 is an electronic block diagram according to a first embodiment of the present invention;

FIG. 2 is an electronic block diagram according to a second embodiment of the present invention;

FIG. 3 is an operational diagram according to an embodiment of enlarging the size of the element on the second digital video image of the present invention;

FIG. 4 is a flow chart according to the method of the present invention;

FIG. 5A is a flow chart according to the process of changing the volume of brightness of the element with a closed contour on the first digital video image;

FIG. 5B is a flow chart according to the process of changing the volume of contrast of the element with a closed contour on the first digital video image;

FIG. 5C is a flow chart according to the process of enlarging the size of the element with a closed contour on the first digital video image; and

FIG. 5D is a flow chart according to the process of being bold of the contour of the element with a closed contour on the first digital video image;

### DESCRIPTION OF THE PREFERRED EMBODIMENTS

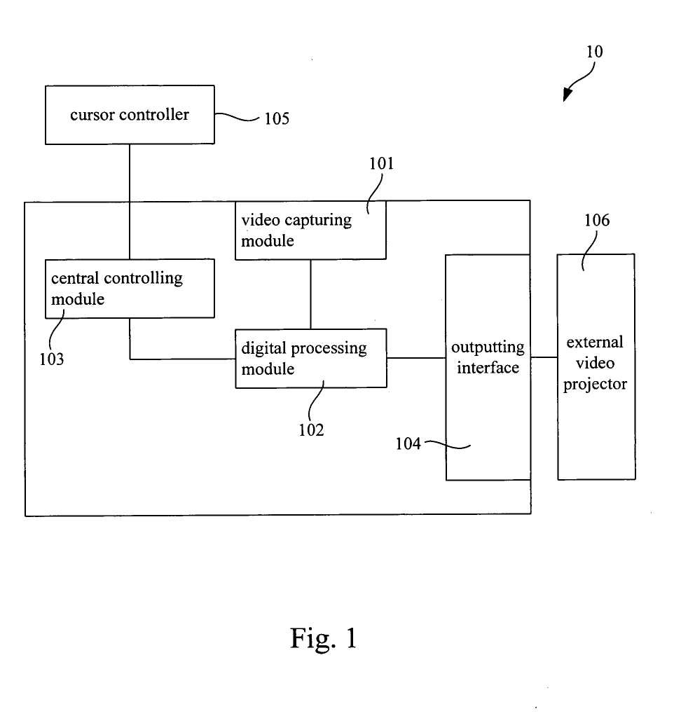

The present invention is to provide a document camera and a method to make an element distinguished from others on a projected image. Please refer to FIG. 1, which shows an electronic block diagram according to a first embodiment of the present invention. The document camera 10 disclosed in a first embodiment comprises a video capturing module 101 (e.g. camera lens), a digital processing module 102 (e.g. digital signal processor, DSP), a central controlling module 103 (e.g. CPU or the like which has the same function) and an outputting interface 104 (e.g. connector), in which the digital processing module 102 is electrically connected to the video capturing module 101, the central controlling module 103 and the outputting interface 104 respectively, the video capturing module 101 is provided to continually capture an object image from an object 20 (e.g. paper or article) and sequentially send the object image to the digital processing module 102, the digital processing module 102 is provided to transform formats of the received object images and process an encoding/decoding procedure to the object image. After that, the digital processing module 102 sequentially sends the object image to the outputting interface 104, and the outputting interface 104 is electrically connected to an external video projector 106. The external video projector 106 is capable of receiving the object image from the outputting interface 104 and outputting the object image outwardly.

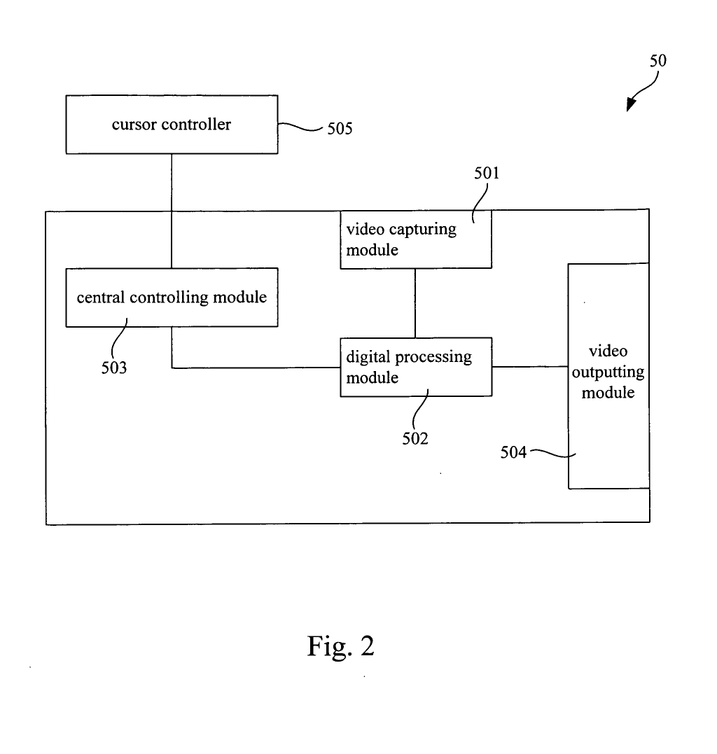

Please refer to FIG. 2, which shows an electronic block diagram according to a second embodiment of the present invention. A document camera 50 disclosed in a second embodiment comprises a video capturing module 501, a digital processing module 502, a central controlling module 503 and a video outputting module 504, in which the digital processing module 502 is electrically connected to video capturing module 501, the central controlling module 503 and the video outputting module 504 respectively, and the video capturing module 501 is provided to continually capture an object image from an object 20 (e.g. paper or article) and sequentially send the object image to the digital processing module 502, the digital processing module 502 is provided to transform formats of the object image and process an encoding/decoding procedure to the object image, after that, the digital processing module 502 sequentially sends the object image to the video outputting module 504, and the video outputting module 504 is provided to output the object image outwardly to a plane (e.g. wall or curtain) after receiving from the digital processing module 502.

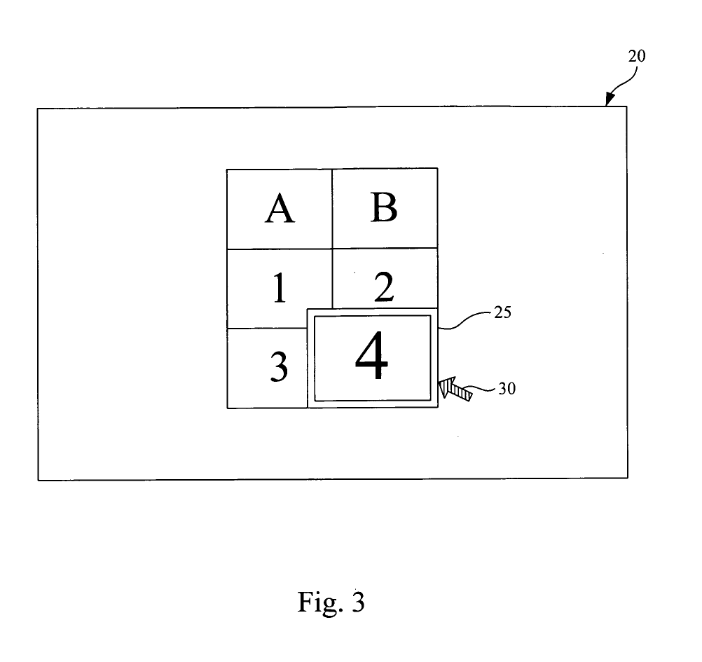

Please refer to FIGS. 1 and 2 again, in those embodiments described above, the document camera 10, 50 can be electrically connected to a cursor controller 105, 505 such as a mouse device, a trace ball device and a remote controller device with wire (including disposed directly on the document cameras 10, 50) or without wire. The central controlling module 103, 503 of the document cameras 10, 50 electrically connected to the cursor controller 105, 505 provides a cursor image 30 on the object image that moves in accordance with a movement performed by the cursor controller 105, 505. Next, the digital processing module 102, 502 pastes the cursor image 30 onto the object image to form a first digital video image. Please refer to FIG. 3, which shows an operational diagram according to an embodiment of enlarging the size of an element 25. Also, the central controlling module 103, 503 is provided to calculate a latest relative position (i.e. coordinate) of the cursor image 30 moving on the first digital video image in accordance with the movement performed by the cursor controller 105, 505. Within the cursor image 30 moving around the first digital video image, the digital processing module 102, 502 will determine whether any element 25 with a closed contour on the first digital video image is detected according to the latest relative position of the cursor image 30 thereon. While an element 25 with the closed contour is detected thereon, the digital processing module 102, 502 will make the element 25 distinguished from others on the first digital video image. To make the element 25 distinguished from others, the digital processing module 102, 502 can enhance the volume of brightness and contrast of the element 25, enlarging the size of the element 25 and reinforce the contour of the element 25. Then, the digital processing module 102, 502 will overlay the distinguished element 25 of the original element on the first digital video image to produce a second digital video image. The external video projector 106 or video outputting module 504 thus outputs outwardly the second digital video image including the cursor image 30 and the distinguished element 25.

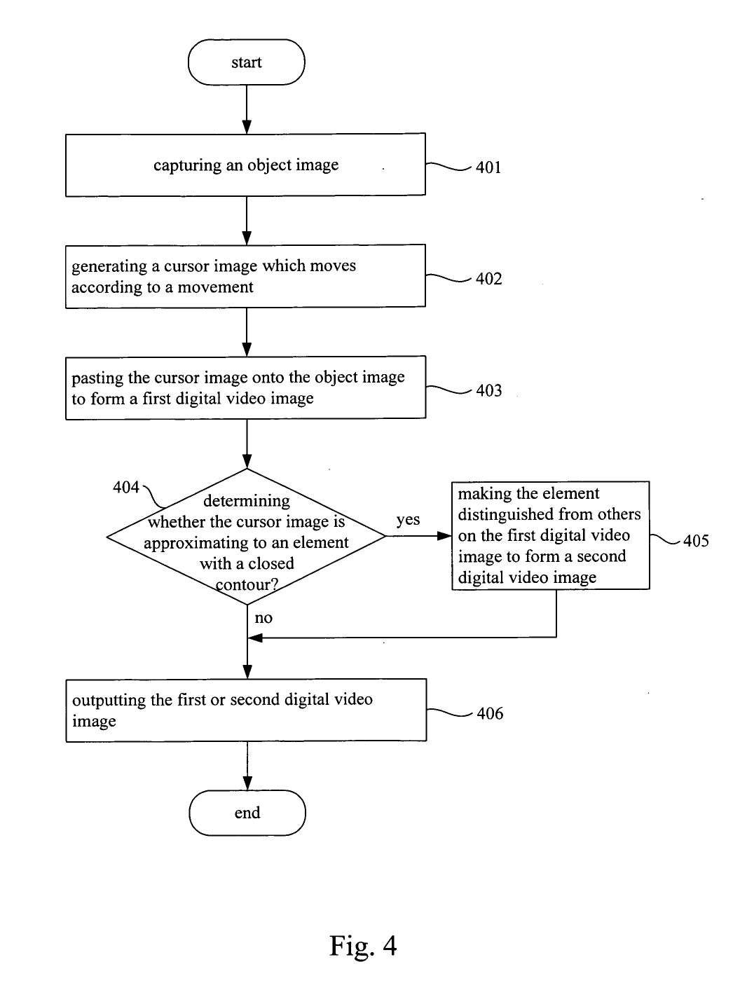

After the document camera 10, 50 with the cursor controller 105, 505 is activated by a user, and the user moves the video capturing module 101, 501 to aim at an object 20, in this embodiment for example is a piece of printed paper. Please refer to FIG. 4, a flow chart according to the method of the present invention. The document camera 10, 50 proceeds with the following steps to make the element 25 distinguished from others:

Step (401) capturing an object image from the object 20:

In this step, the video capturing module 101, 501 shoots the printed paper and continually captures an object image, then the video capturing module 101, 501 sequentially sends them to the digital processing module 102, 502. The digital processing module 102, 502 transforms the format of the object image from analog format into digital format, and processes the encoding/decoding procedure on the object image;

Step (402) generating a cursor image 30 which moves according to a movement:

In this step, the central controlling module 103, 503 calculates a latest relative coordinate (X, Y) of the cursor image 30 on the object image in accordance with a movement performed by the cursor controller 105, 505.

Step (403) pasting the cursor image 30 onto the object image:

The digital processing module 102, 502 shows a cursor image 30 on the object image base on the position of the latest relative coordinate thereof calculated by the central controlling module 103, 503 on step (402), thus the object image with a cursor image is defined as a first digital video image.

Step (404) determining whether the cursor image 30 is approximating to any element 25 with a closed contour on the first digital video image:

In this step, the digital processing module 102, 502 will detect whether an element 25 with the closed contour is in a predetermined scope (e.g. around 50 pixels) of the coordinate of the cursor image 30 on the first digital video image by Edge Detection Method or Closed Contour Extraction Method. In this embodiment the element 25 for example is a chart printed of the printed paper. The document camera 10, 50 goes to step (405), if the digital processing module 102, 502 indeed detects an element with the closed contour, otherwise, the document camera 10, 50 goes to step (406). In the invention, it hereby needs to be understood that the closed contour of the element 25 described above is defined that the border of the element 25 is displayed with a completely enclosed line, not broken lines.

There are further other well-known methods to detect the feature of closed contour. These methods, like “Edge Detection Method”, “Closed Contour Extraction Method”, “Sobel Method ”and “Laplacian of Gaussian method” etc., basically aim to analyze and determine that the border line of a target is a continual loop or not, but the result cannot be exactly the same due to different algorithm thereof. Normally, these methods are deemed a pre-process of image processing before a mainly image process. Since these methods are all well-known and common knowledge within the current age, and are not solely the main subject matter of the present invention, that detail of these methods will not be separately disclosed further.

Step (405) making the element 25 distinguished from others on the first digital video image, while the element 25 with the closed contour is detected;

When the element 25 with the closed contour approximated to the cursor image 30 on the first digital video image is detected by the digital processing module 102, 502, the digital processing module 102, 502 firstly acquires an element image from the element 25 with closed contour through a user interface (not shown) of the document camera 10, 50. The user interface provides such options as follows for selection to make a distinguished element image of the element 25 in which the element image includes its appearance, all of pixels of the element image and Red, Green and Blue three primary colors of light (RGB) of all pixels.

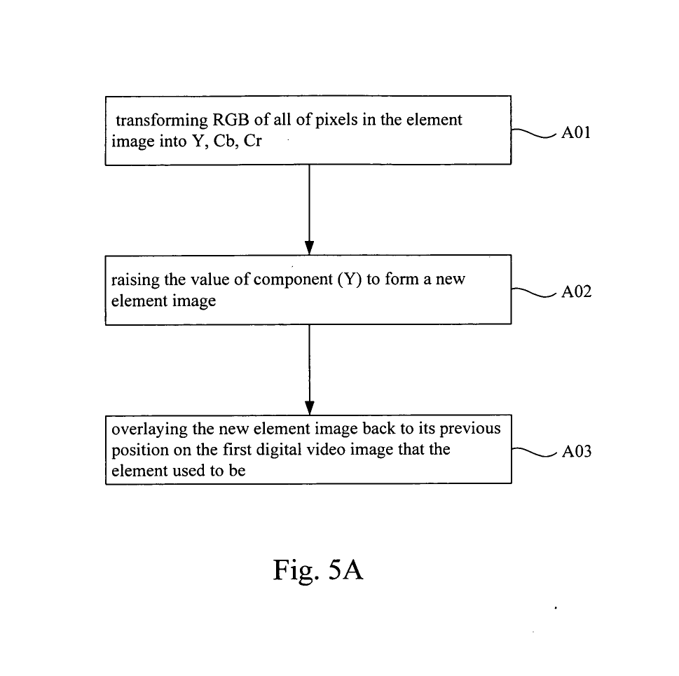

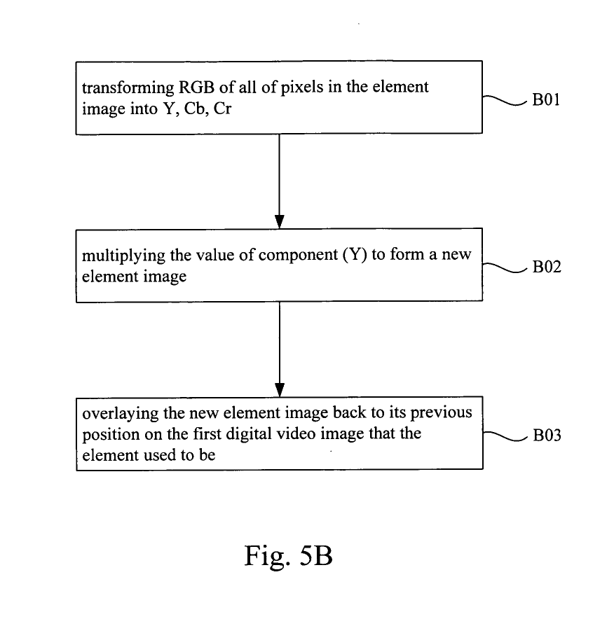

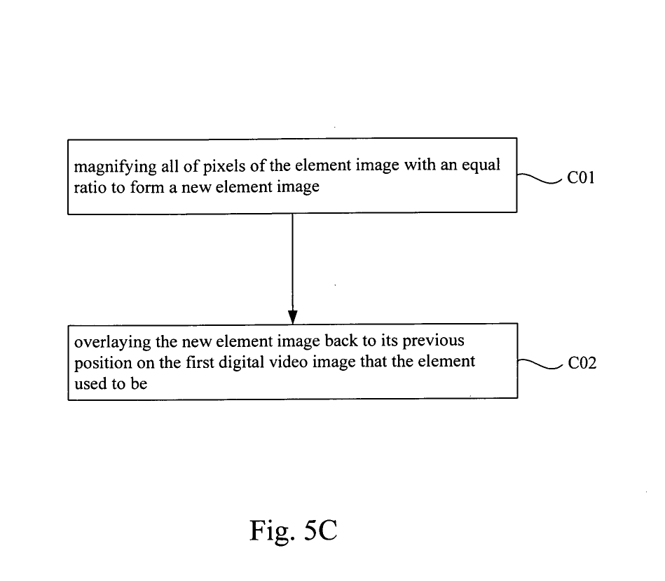

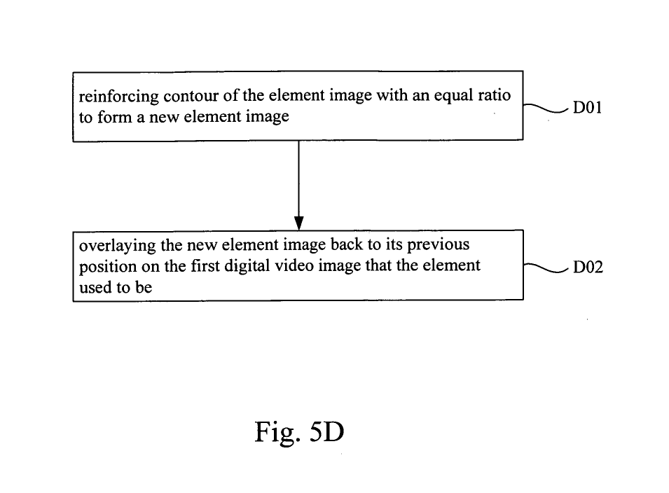

The first option provided in this embodiment is to perform a process of enhancing the volume of brightness of the element image on the first digital video image. Please refer to FIG. 5A, which shows a flow chart according to the process of changing the volume of brightness of the element 25 with closed contour on the first digital video image. The process includes:

Step (A01) transforming the Red, Green and Blue three primary colors of light (RGB) of all of pixels in the element image into color difference signals (Y, Cb, Cr) based on formulae below:

Component (Y) from color difference signals (Y, Cb, Cr)=(0.257*component(R))+(0.504*component(G))+(0.098*component(B))+16

Component (Cr) from color difference signals (Y, Cb, Cr)=(0.439*component(R))−(0.368*component(G))−(0.071*component(B))+128

Component (Cb) from color difference signals (Y, Cb, Cr)=−(0.148*component(R))−(0.291*component(G))−(0.439*component(B))+128

Step (A02) raising the value (i.e. increasing 50) of component (Y) from color difference signals (Y, Cb, Cr) of all of pixels in the element image to form a new element image; and

Step (A03) overlaying the new element image back to the previous position on the first digital video image that the element 25 used to be to form a second digital video image.

The second option provided in this embodiment is to perform a process of enhancing the volume of contrast of the element image on the first digital video image. Please refer to FIG. 5B, which shows a flow chart according to the process of changing the volume of contrast of the element 25 with closed contour on the object image. The process includes:

Step (B01) transforming the Red, Green and Blue three primary colors of light (RGB) of all of pixels in the element image into color difference signals (Y, Cb, Cr) based on formulae below:

Component (Y) from color difference signals (Y, Cb, Cr)=(0.257*component(R))+(0.504*component(G))+(0.098*component(B))+16

Component (Cr) from color difference signals (Y, Cb, Cr)=(0.439*component(R))−(0.368*component(G))−(0.071*component(B))+128

Component (Cb) from color difference signals (Y, Cb, Cr)=−(0.148*component(R))−(0.291*component(G))−(0.439*component(B))+128

Step (B02) multiplying the value (i.e. 1.5 times) of component (Y) from color difference signals (Y, Cb, Cr) of all of pixels in the element image to form a new element image; and

Step (B03) overlaying the new element image back to the previous position on the first digital video image that the element 25 used to be to form a second digital video image.

The third option provided in this embodiment is to perform a process of enhancing the size of the element image on the first digital video image. Please refer to FIG. 5C, which shows a flow chart according to the process of enlarging the size of the element 25 with closed contour on the object image. The process includes:

Step (C01) magnifying all of pixels of the element image with an equal ratio (e.g. 1.5 times) to form a new element image; and

Step (C02): overlaying the new element image back to the previous position on the first digital video image that the element 25 used to be to form a second digital video image.

The forth option provided in this embodiment is to perform a process of being bold contour of the element image on the first digital video image. Please refer to FIG. 5D, which shows a flow chart according to the process of bolding the contour of the element 25 with closed contour on the object image. The process includes:

Step (D01) reinforcing a contour of the element image with an equal ratio (e.g. 1.5 times) to form a new element image; and

Step (D02) overlaying the new element image back to the previous position on the first digital video image that the element 25 used to be to form a second digital video image.

Step (406) outputting the first or second digital video image:

When the digital processing module 102, 502 does not detect any element with the closed contour, the digital processing module 102 will send the first digital video image to either the video outputting module 504 or the outputting interface 104, otherwise, the digital processing module 102, 502 will send the second digital video image transmitted to either the video outputting module 504 or the outputting interface 104 to enable the video outputting module 504 to project the second digital video image onto a plane (e.g. wall or curtain) or enable the outputting interface 104 to output to the external video projector 106.

Thus, the chart will change its brightness, contrast, size or contour on to the second digital video image at which the chart used to position, whenever a cursor image 30 controlled approaches the chart by the user. Therefore, the audience would clearly see an introducing target and follow the presentation point easily without the effect of unobvious light-spot of the laser pointer, tiny cursor and bad printing quality of the printed paper. The technique features and the method in this present invention are quite novel, creative and unpredictably effective from the prior arts, accordingly the invention is patentable and worthy to be granted.

Thus, the typically technique features are not only limited to those discussed above, especially some technique features can be modified as follows:

1. The options to make the element 25 distinguished are not limited to the four options introduced above, therefore any process attempted to get audience's attention, such as the change of color or pattern of the element 25, also is requested to be covered in this invention;

2. The way to control the cursor image 30 moving on the object image is unlimited to the hardware (i.e. cursor controller 105, 505), any cursor image 30 provided by which another moving object (i.e. pen point, fingertip or light spot) is being continually captured upon the object 20 with “Motion Detection software”, and the digital processing module provides the central controlling module to calculate a coordinate of the cursor image on the object image in accordance with a movement performed by another object also are requested to be covered in this invention;

3. The method for detecting the feature of closed contour is not limited to the edge detection method and the closed contour extraction method, therefore any concept able to help detect the element 25 with a closed contour also is requested to be covered in this invention;

While the invention herein disclosed has been described by means of specific embodiments, numerous modifications and variations could be made thereto by those skilled in the art without departing from the scope and spirit of the invention set forth in the claims.

What is claimed is:

1. A document camera, comprising:
a video capturing module capable of continually capturing an object image;
a central controlling module capable of providing a coordinate of a cursor image which moves according to a movement;
a digital processing module electrically connected to the video capturing module and the central controlling module respectively, and capable of pasting the cursor image on the object image according to the coordinate of the cursor image to produce a first digital video image, detecting an element with closed contour on the first digital video image according to the coordinate of the cursor image, making the element distinguished from others on the first digital video image and overlaying the distinguished element on the first digital video image to produce a second digital video image; and
an output interface electrically connected to the digital processing module, and capable of outputting the second digital video image.

2. The document camera as claimed in claim 1, further comprising a cursor controller electrically connected to the central controlling module and providing the central controlling module to calculate the coordinate of the cursor image on the object image in accordance with the movement performed by the cursor controller.

3. The document camera as claimed in claim 2, wherein the cursor controller is a mouse device, a trace ball device and a remote controller device.

4. The document camera as claimed in claim 1, wherein the video capturing module is further capable of continually capturing an image of another object moving upon the object, and the digital processing module is providing the central controlling module to calculate the coordinate of the cursor image on the object image in accordance with a movement performed by another object.

5. The document camera as claimed in claim 4, wherein another object is a pen point, a fingertip or a light spot.

6. The document camera as claimed in claim 1, wherein the output interface is electrically connected to an external video projector capable of receiving the second digital video image from the output interface and outputting the second digital video image outwardly.

7. A document camera comprising:
a video capturing module capable of continually capturing an object image;
a central controlling module capable of providing a coordinate of a cursor image which moves according to a movement;
a digital processing module electrically connected to the video capturing module and the central controlling module respectively, and capable of pasting the cursor image on the object image according to the coordinate of the cursor image to produce a first digital video image, detecting an element with closed contour on the first digital video image according to the coordinate of the cursor image, making the element distinguished from others on the first digital video image and overlaying the distinguished element on the first digital video image to produce a second digital video image; and
a video outputting module electrically connected to the digital processing module, and capable of outputting the second digital video image outwardly.

8. The document camera as claimed in claim 7 further comprising a cursor controller electrically connected to the central controlling module and providing the central controlling module to calculate the coordinate of the cursor image on the object image in accordance with the movement performed by the cursor controller.

9. The document camera as claimed in claim 8, wherein the cursor controller is a mouse device, a trace ball device and a remote controller device.

10. The document camera as claimed in claim 7, wherein the video capturing module is further capable of continually capturing an image of another object moving upon the object, and the digital processing module is providing the central controlling module to calculate the coordinate of the cursor image on the object image in accordance with a movement performed by another object.

11. The document camera as claimed in claim 10, wherein the other object is a pen point, a fingertip or a light spot.

12. A method to distinguish an element from others on a projected image, which implements on a document camera, comprising:
capturing an image from an object;
generating a cursor image and pasting it onto the image according to a coordinate of the cursor image which moves according to a movement performed by a cursor controller;
determining whether the cursor image on the image is approximate to an element with closed contour;
making the element distinguished from others on the image, while the cursor image on the image is approximate to the element with closed contour;
outputting the image with the distinguished element.

13. The method as claimed in claim 12, wherein the cursor image in the step of generating is processed by a central processing module of the document camera to calculate the coordinate of the cursor image on the image in accordance with the movement performed by the cursor controller.

14. The method as claimed in claim 13, wherein the step of pasting the cursor image is processed by a digital processing module of the document camera to paste the cursor image on the image according to the coordinate of the cursor image on the image.

15. The method as claimed in claim 14, wherein the step of determining is processed by the digital processing module to detect whether an element with closed contour is in a predetermined scope of the coordinate of the cursor image on the image by Edge Detection Method.

16. The method as claimed in claim 14, wherein the step of determining is processed by the digital processing module to detect whether an element with closed contour is in a predetermined scope of the coordinate of the cursor image on the image by Closed Contour Extraction Method.

17. The method as claimed in claim 14, wherein the step of making is processed by the digital processing module according to the following steps:
acquiring an element image from the element with closed contour approximate to the cursor image on the image; and
performing a process of enhancing the volume of brightness of the element image on the image.

18. The method as claimed in claim 17, wherein the step of performing further comprising:
transforming Red, Green and Blue three primary colors of light (RGB) of all of pixels in the element image into color difference signals (Y, Cb, Cr);
raising the value of component (Y) from color difference signals (Y, Cb, Cr) of all of pixels in the element image to form a new element image; and
overlaying the new element image back to the previous position on the image that the element used to be.

19. The method as claimed in claim 14, wherein the step of making is processed by the digital processing module according to the following steps:
acquiring an element image from the element with closed contour approximate to the cursor image on the image; and
performing a process of enhancing the volume of contrast of the element image on the image.

20. The method as claimed in claim 19, wherein the step of performing further comprising:
transforming Red, Green and Blue three primary colors of light (RGB) of all of pixels in the element image into color difference signals (Y, Cb, Cr);
multiplying the value of component (Y) from color difference signals (Y, Cb, Cr) of all of pixels in the element image to form a new element image; and
overlaying the new element image back to the previous position on the image that the element used to be.

21. The method as claimed in claim 14, wherein the step of making is processed by the digital processing module according to the following steps:
acquiring an element image from the element with closed contour approximate to the cursor image on the image; and
performing a process of enhancing the size of the element image on the image.

22. The method as claimed in claim 21, wherein the step of performing further comprising:
magnifying all of pixels of the element image with an equal ratio to form a new element image; and
overlaying the new element image back to the previous position on the image that the element used to be.

23. The method as claimed in claim 14, wherein the step of making is processed by the digital processing module according to the following steps:
acquiring an element image from the element with closed contour approximate to the cursor image on the image; and
performing a process of being bold contour of the element image on the image.

24. The method as claimed in claim 23, wherein the step of performing further comprising:
reinforcing a contour of the element image with an equal ratio to form a new element image; and
overlaying the new element image with closed contour back to the previous position on the image that the element used to be.
